(19) United States
(12) Patent Application Publication
(10) Pub. No.: US 2010/0260530 A1
(43) Pub. Date: Oct. 14, 2010

(54) APPARATUS FOR DISPENSING VISCOUS FLUID, AND TOOL AND METHOD FOR DISPENSING DRYWALL JOINT COMPOUND

(76) Inventors: Werner L. Schlecht, Paradise Valley, AZ (US); David T. Roman, Chandler, AZ (US)

Correspondence Address: BRYAN CAVE LLP, TWO NORTH CENTRAL AVENUE, SUITE 2200, PHOENIX, AZ, 85004, US

(21) Appl. No.: 12/729,113

(22) Filed: Mar. 22, 2010

Related U.S. Application Data
(60) Provisional application No. 61/162,002, filed on Mar. 20, 2009.

(51) Int. Cl. B28B 3/00; A46B 17/02; A21C 11/00

(52) U.S. Cl. 401/48; 425/87; 425/458

(57) ABSTRACT

Apparatuses for dispensing viscous fluids, tools for dispensing drywall joint compound, and methods. Embodiments include a chamber containing the fluid or compound, a discharge head, and a valve that is normally closed and opens in response to a force applied by pressing the tool against the drywall. Embodiments include a stopper linked to the nozzle, and when the nozzle is moved, the stopper moves from blocking an orifice, to not blocking the orifice. Chambers include a pressure plate, two side plates, a back plate, and a radius plate, and at least one spring or spring hinge that applies a force on the pressure plate. A torsion spring may be substantially concentric with the pivot point. Certain methods obtain or provide a source of pressurized drywall joint compound, an attachment feature, a valve, an enclosed passageway, and a linkage from the attachment feature to the valve.

### RELATED PATENT APPLICATIONS

This patent application claims priority to U.S. Provisional Patent Application No. 61/162,002, filed on Mar. 20, 2009, titled APPARATUS FOR DISPENSING VISCOUS FLUID, TOOL FOR DISPENSING DRYWALL JOINT COMPOUND, AND METHODS, having the same inventors, the contents of which are incorporated herein by reference. This patent application has the same disclosure, but different claims, as a patent application titled: TOOL FOR DISPENSING DRYWALL JOINT COMPOUND filed on the same date, and having the same inventors, that also claims priority to the same provisional patent application. This patent application is also related to, and incorporates by reference, a PCT patent application titled, TOOL FOR DISPENSING DRYWALL JOINT COMPOUND, APPARATUS FOR DISPENSING VISCOUS FLUID, AND METHOD, filed on the same date as this patent application and having the same inventors.

### FIELD OF THE INVENTION

The present invention relates to apparatuses for dispensing viscous fluids and methods of making and using such devices. Particular embodiments concern tools and methods for dispensing drywall joint compound, for example, into joints between sheets of drywall.

### BACKGROUND OF THE INVENTION

Various apparatuses have been invented and used for dispensing fluids including viscous fluids. In a specific application, for example, a number of apparatuses or tools have been invented and used for dispensing drywall joint compound, for instance, between sheets of drywall. Drywall, also known as gypsum board, wallboard, and plasterboard, is a building material used to finish the interior surfaces of walls and ceilings in houses and other buildings. Rigid sheets or panels of drywall are formed from gypsum plaster, the semi-hydrous form of calcium sulphate (CaSO4.½H2O), which is typically sandwiched between two layers of heavy paper or fiberglass mats. Drywall sheets are about ½ inch thick and are nailed or screwed in place to form the interior surfaces of the building, and provide fire resistance and sound deadening, among other benefits.

The joints between drywall sheets are typically filled and sealed with strips of paper or fiberglass mat and drywall joint compound, also called “joint compound”, “drywall mud”, or just “mud”. Joint compound may be made, for example, of water, limestone, expanded perlite, ethylene-vinyl acetate polymer and attapulgite. Joint compound is applied as a viscous fluid that is thick enough to maintain its shape while it hardens. In addition to forming joints, drywall mud is used to cover nail or screw heads, form a smooth or flat surface, and provide a texture over the surface. Paint or wall paper is typically applied over the drywall and joint compound.

Workers often specialize in the installation of drywall, and in large projects, different crews install the drywall panels (drywall hangers) from those who finish the joints and apply the joint compound (tapers or mudmen). Workers who specialize in drywall installation often use specialized tools to increase their productivity including flat boxes that are tools used to hold joint compound and apply it to drywall joints. Joint compound is often mixed (e.g., with water) or stored in buckets, and drywall mud pumps have been used to pump the mud from the buckets into flat boxes or other tools or containers.

U.S. Pat. No. 7,473,085, U.S. patent application Ser. No. 11/453,455, publication 2007/0292196 (also by Werner Schlecht) describes a drywall finishing tool that is commonly referred to as a “flat box”, which is used to apply drywall joint compound between sheets of drywall that are in the same plane (e.g., that form parts of the same wall). Flat boxes have been used successfully to apply drywall joint compound between sheets of drywall that are in the same plane, but room for improvement exists for their adaptation to satisfactorily apply drywall joint compound to inside corners (e.g., the corners of a room) where sheets of drywall come together, typically, at a substantially right angle. Thus, needs and potential for benefit exist for adaptations and improvements to flat boxes to allow them to better apply drywall joint compound to inside corners where sheets of drywall come together at a substantially right angle, for instance.

In addition, a product has been on the market for some time that is used to apply drywall joint compound to inside corners (e.g., the corners of a room) where sheets of drywall come together at a substantially right angle, for example. This product has a cylinder that contains drywall joint compound and a spring that pushes a piston to pressurized the drywall joint compound. A valve controls the dispensing of the drywall joint compound. The valve is opened and closed by the operator through a linkage to a leaver that the operator moves with one hand. This product is heavy, however, when filled with drywall joint compound, and it is difficult to hold the tool, guide the tool to smooth the drywall joint compound on the sheets of drywall, and operate the lever that controls the valve, all at the same time. Needs and potential for benefit exist for a drywall dispensing tool that is easier to operate, particularly, that is suitable for forming inside corners.

In addition, drywall joint compound can have varying viscosities depending on, among other things, how much water is used when mixing the compound. Different viscosities may work better in different circumstances, and different operators may prefer different viscosities. Dispensing tools that pressurize drywall joint compound may work best with different amounts of pressure depending on the viscosity of the drywall joint compound or the preference of the operator. As a result, needs and potential for benefit exist for dispensing tools that provide for the operator to be able to vary the pressure of the drywall joint compound to compensate for viscosity, to provide for optimization, to adjust for personal preference, to adjust for particular circumstances, or a combination thereof, as examples.

Furthermore, as mentioned, drywall mud pumps have been used to pump drywall joint compound from buckets into tools for dispensing the compound onto the sheets of drywall. U.S. patent application Ser. No. 11/292,238, publication 2007/0122301 (also by Werner Schlecht) describes a drywall mud pump. When tools are used wherein the drywall joint compound is pressurized, it has been necessary to form a good seal between the pump and the tool to avoid leakage, and considerable effort has been required to pump drywall joint compound into the tool. Consequently, needs and potential for benefit exist for tools that provide reduced or no back pressure to the drywall mud pump when filling the tool with drywall joint compound.

In addition, needs and potential for benefit exist for drywall joint compound dispensing tools, and other apparatuses for dispensing viscous fluids, that are inexpensive to manufacture, reliable, easy to use, that have a long life, that are easy to service and clean, and that are simple in operation so that typical operators can effectively maintain them. Room for improvement exists over the prior art in these and other areas that may be apparent to a person of ordinary skill in the art having studied this document. Other needs and potential for benefit may also be apparent to a person of skill in the art of specialized drywall tools.

### BRIEF DESCRIPTION OF THE DRAWINGS

FIG. 1 is an isometric view of an improved apparatus for dispensing a viscous fluid, such as a tool for dispensing drywall joint compound (e.g., between sheets of drywall);

FIG. 2 is an isometric view of part of the improved apparatus of FIG. 1 for dispensing a viscous fluid (such as a tool for dispensing drywall joint compound between sheets of drywall), this particular part including a chamber for containing the fluid and a discharge head for delivering the fluid from the chamber;

FIG. 3 is a side view of the part of the apparatus or tool of FIG. 2;

FIG. 4 is a front view of the part of the apparatus or tool of FIGS. 2 and 3;

FIG. 5 is a cross-sectional side view of the part of the apparatus or tool of FIGS. 2-4;

FIG. 6 is a cross-sectional top view of the part of the apparatus or tool of FIGS. 2-5;

FIG. 7 is a bottom view of the part of the apparatus or tool of FIGS. 2-6;

FIG. 8 is a view of the pressure plate of the part of the apparatus or tool of FIGS. 2-7;

FIG. 9 is a side view (opposite side from FIG. 3) of the part of the apparatus or tool of FIGS. 2-8;

FIG. 10 is an isometric view of a nozzle of the apparatus or tool of FIG. 1 and the part of the apparatus or tool of FIGS. 2-9;

FIG. 11 is an isometric view of a cross member that fits inside the nozzle of FIG. 10;

FIG. 12 is an end view (a top view from the perspective of FIGS. 3-5) of the nozzle of FIG. 10 showing the cross member of FIG. 11 inside;

FIG. 13 is an isometric view of a of a stopper and linkage or rod that fits partially inside the nozzle of FIG. 10, and that fits inside the discharge head of FIGS. 2-5, 7, and 9;

FIG. 14 is an isometric view of a valve bushing that fits partially inside the nozzle of FIG. 10 and that is part of the discharge head of FIGS. 2-5, 7, and 9;

FIG. 15 is an isometric view of a bracket that attaches the discharge head of FIGS. 2-5, 7, and 9 to the back plate of the chamber;

FIG. 16 is a top view of a torsion spring assembly that fits inside the pressure plate concentric with the pivot point to apply a force against the pressure plate, for example, to pressurize the chamber of the apparatus or tool of FIG. 1;

FIG. 17 is an isometric view of a long spring end plug of the spring assembly of FIG. 16;

FIG. 18 is an isometric view of a short spring end plug of the spring assembly of FIG. 16;

FIG. 19 is an isometric view of a spring hinge of the apparatus or tool of FIGS. 1-9 that applies a force against the pressure plate;

FIG. 20 is a cross-sectional view of the spring hinge of FIG. 19 showing, among other things, the torsion spring and spring end plugs;

FIG. 21 is an isometric view of a spring lock that is part of a spring lockout mechanism of the apparatus or tool of FIGS. 1-9;

FIG. 22 is an isometric view of a lockout bar that is part of a spring lockout mechanism of the apparatus or tool of FIGS. 1-9;

FIG. 23 is an isometric view of the apparatus or tool of FIG. 1, from a different angle, illustrating the surfaces and edges of the angle head attachment; and

FIG. 24 is a flow chart illustrating an example of a method, for instance, of providing for the dispensing of drywall joint compound into joints between sheets of drywall by obtaining or providing at least one improved drywall tool.

The drawings illustrate, among other things, various examples of embodiments of the invention, and certain examples of characteristics thereof. Other embodiments may differ. Different embodiments of the invention include various combinations of elements or acts shown in the drawings, described herein, known in the art, or a combination thereof, for instance.

### SUMMARY OF PARTICULAR EMBODIMENTS OF THE INVENTION

Various embodiments provide, for example, as an object or benefit, that they partially or fully address or satisfy one or more of the needs, potential areas for benefit, or opportunities for improvement described herein, or known in the art, as examples. Some embodiments of the invention provide various apparatuses for dispensing viscous fluids, for example, tools for dispensing drywall joint compound, for instance, between and/or over sheets of drywall. Workers or operators may use such tools, for example, who specialize in the installation of drywall, or specifically, those who finish the joints and apply the joint compound (tapers or mudmen), for instance. Various embodiments provide, for example, as an object or benefit, that they provide specialized tools to increase the productivity of such workers, including tools used to hold joint compound and apply it to drywall joints.

A number of embodiments provide, for example, as objects or benefits, adaptations and improvements to flat boxes to allow them to apply drywall joint compound to inside corners where sheets of drywall come together at a substantially right angle, for instance. In addition, various embodiments provide, for instance, as an object or benefit, that they provide a drywall dispensing tool that is easier to operate, for example, easier to control the release of drywall joint compound while holding the tool and smoothing the joint compound. Furthermore, some embodiments provide, as an object or benefit, for instance, that they provide dispensing tools that provide for the operator to be able to vary the pressure of the drywall joint compound, for instance, to compensate for varying viscosity, to provide for optimization, to adjust for personal preference, to adjust for particular circumstances, or a combination thereof, as examples.

Moreover, certain embodiments provide, as an object or benefit, for example, tools that provide reduced back pressure to the drywall mud pump when filling the tool with drywall joint compound. In addition, particular embodiments provide, as an object or benefit, for instance, drywall joint compound dispensing tools, and other apparatuses for dispensing viscous fluids, that are inexpensive to manufacture, reliable, easy to use, that have a long life, that are easy to service and clean, and that are simple in operation so that typical operators can effectively maintain them.

Benefits of various embodiments of the invention exist over the prior art in these and other areas that may be apparent to a person of ordinary skill in the art having studied this document. These and other aspects of the present invention may be realized in whole or in part in various tools for dispensing drywall joint compound and apparatuses for dispensing viscous fluids as shown, described, or both in the figures and related description herein. Other objects and benefits may also be apparent to a person of skill in the art of specialized drywall tools or of other apparatuses for dispensing viscous fluids, for example. Besides tools for dispensing drywall joint compound, some embodiments may be used for other purposes.

Specific embodiments of the invention provide various improved apparatuses, for example, for dispensing a viscous fluid in a controlled manner. Such an apparatus may include, for example, a chamber for containing pressurized viscous fluid, a discharge head which, when the apparatus is assembled, may be connected to the chamber, for instance, for delivering the viscous fluid from the chamber through the discharge head, and a nozzle which, when the apparatus is assembled, may be connected to the discharge head, for example, for delivering the viscous fluid from the chamber through the discharge head and through the nozzle. In some embodiments, the nozzle and the discharge head may be configured so that the nozzle will move relative to the discharge head, for instance, over a predetermined range of distance from a first end of the range of distance to a second end of the range of distance.

Various embodiments may include an orifice in the discharge head or the nozzle, for example, and when the apparatus is assembled and is used for dispensing the viscous fluid, the viscous fluid passes through the orifice. A number of embodiments may further include a stopper which, when the apparatus is assembled, may be linked to the nozzle or to the discharge head, and in some embodiments, the nozzle may be located in the orifice, and when the nozzle is moved over the predetermined range of distance, the stopper may move from blocking the orifice at the first end of the range of distance, to not blocking the orifice at the second end of the range of distance. In some embodiments, the nozzle, the orifice, and the stopper may have a substantially common axis, and in particular embodiments, the nozzle may translate linearly in the direction of the axis when the nozzle moves relative to the discharge head over the predetermined range of distance. Further, in some embodiments, the stopper may be linked to the nozzle or to the discharge head through a rod, for example, that extends along the axis within the orifice.

In particular embodiments, the chamber may include, for instance, a pressure plate, two side plates, a back plate, and a radius plate, and in some embodiments, the pressure plate pivots about a pivot point that may be stationary relative to the side plates, the back plate, and the radius plate. Further, in a number of embodiments, the apparatus includes at least one spring which may apply a force on the pressure plate, for instance, to bias the pressure plate toward the back plate and thereby pressurize the viscous fluid within the chamber, for example, when the apparatus is assembled and the chamber contains the viscous fluid. In certain embodiments, when the apparatus is assembled, the discharge head may be mounted on the back plate and the back plate may include, for instance, an orifice forming a conduit for the viscous fluid from the chamber to the valve.

In a number of embodiments, the at least one spring may include, for instance, a torsion spring, and in some embodiments, when the apparatus is assembled, the torsion spring may be substantially concentric with the pivot point, for example. Further, in some embodiments, the at least one spring may include, for instance, a spring hinge having a pivot point, and in some embodiments, when the tool is assembled and the chamber is substantially filled with drywall joint compound, the spring hinge may press against the pressure plate. In some embodiments, the spring hinge may include, for instance, a torsion spring and in particular embodiments, when the tool is assembled, the torsion spring may be substantially concentric with the pivot point of the spring hinge. Further, in certain embodiments, the spring hinge may include, for instance, an end plug having a regular polygonal portion, and in some embodiments, the polygonal portion can be rotated to adjust the preload of the torsion spring and thereby adjust how hard the spring hinge presses against the pressure plate. Certain embodiments may include, for example, a spring lock-out mechanism reducing or eliminating (or both) pressure of the pressurized viscous fluid, for example, to facilitate filling the apparatus with the viscous fluid.

Certain specific embodiments of the invention provide particular improved tools, for example, for use by an operator for dispensing drywall joint compound into joints between sheets of drywall. Such a tool may include, for example, a chamber for containing pressurized drywall joint compound, a discharge head which, when the tool is assembled, may be connected to the chamber for delivering the drywall joint compound from the chamber, through the discharge head, to the joints between the sheets of drywall, and a valve in the discharge head. In some embodiments, when the tool is in operation, the valve may normally be closed to prevent the drywall joint compound from passing from the chamber through the discharge head. Further, in some embodiments, the valve may be configured to open to permit the drywall joint compound to pass through the discharge head in response to a force vector that may be applied to the discharge head, for example, by the operator pressing the tool against at least one of the sheets of drywall.

In particular embodiments, the chamber may include, for instance, a pressure plate, two side plates, a back plate, and a radius plate, and in certain embodiments, the pressure plate may pivot about a pivot point that may be stationary relative to the side plates, the back plate, and the radius plate. In certain embodiments, the tool further includes at least one spring which may apply a force on the pressure plate, for example, to bias the pressure plate toward the back plate and thereby pressurize the drywall joint compound within the chamber when the tool is assembled and the chamber contains the drywall joint compound. Moreover, in some embodiments, the tool may further include, for instance, an elongated handle which, when the tool is assembled, may be attached to the pressure plate, and in some embodiments, the tool further may include, for instance, a seal which, when the tool is assembled, may be mounted on the pressure plate and may contact the two side plates, the radius plate, or a combination thereof, for instance, to prevent or reduce leakage of the drywall joint compound past the pressure plate.

In some embodiments, when the tool is assembled, the discharge head may be mounted on the back plate and the back plate may include, for instance, an orifice therethrough, forming a conduit for the joint compound, for example, from the chamber to the valve. Furthermore, in some embodiments, the at least one spring may include, for instance, a torsion spring, and in some embodiments, when the tool is assembled, the torsion spring may be substantially concentric with the pivot point, for example. Even further, in some embodiments, the at least one spring may include, for instance, a spring hinge having a pivot point, and in some embodiments, when the tool is assembled and the chamber is substantially filled with drywall joint compound, the spring hinge may press against the pressure plate, for example.

In particular embodiments, the spring hinge may include, for instance, a torsion spring, and in some embodiments, when the tool is assembled, the torsion spring may be substantially concentric with the pivot point of the spring hinge, for example. Additionally, in some embodiments, the spring hinge may include, for instance, an end plug, for example, having a regular polygonal portion, and in some embodiments, the polygonal portion can be rotated to adjust the preload of the torsion spring and thereby adjust how hard the spring hinge presses against the pressure plate, for example. Further, in some embodiments, the improved tool may further include, for example, a spring lock-out mechanism, for instance, for reducing or eliminating pressure of the pressurized drywall joint compound, for example, to facilitate filling the tool with drywall joint compound.

In some embodiments, the discharge head may include, for instance, an attachment feature, for instance, for removably attaching (e.g., one at a time) a plurality of attachments. In certain embodiments, the attachments may include, for example, at least one flat surface, at least one straight edge, or both, for instance, for smoothing the drywall joint compound in the joints between the sheets of drywall. And in some embodiments, the force vector may be applied to the discharge head by the operator by pressing the flat surface or the straight edge against at least one of the sheets of drywall. Further, in particular embodiments, the improved tool may further include, for example, at least one attachment having at least two flat surfaces forming a substantially right angle therebetween and at least two intersecting straight edges for smoothing the drywall joint compound in an inside corner formed between two of the sheets of drywall.

In particular embodiments, the improved tool may include, for example, a nozzle which, when the tool is assembled, may be connected to the discharge head, for instance, for delivering the drywall joint compound from the chamber through the discharge head and through the nozzle. In some embodiments, the nozzle and the discharge head may be configured so that the nozzle will move relative to the discharge head over a predetermined range of distance from a first end of the range of distance to a second end of the range of distance. Further, in some embodiments, the valve may include, for instance, an orifice, and in some embodiments, when the tool is assembled and is used for dispensing the drywall joint compound, the drywall joint compound may pass through the orifice.

Moreover, in some embodiments, the valve may include, for instance, a stopper which, when the tool is assembled, may be linked to the nozzle and may be located in the orifice. In some embodiments, when the nozzle is moved over the predetermined range of distance, the stopper may move from blocking the orifice at the first end of the range of distance, to not blocking the orifice at the second end of the range of distance, for example. Still further, in some embodiments, the nozzle, the orifice, the stopper, or a combination thereof, may have a common axis. Further still, in some embodiments, the nozzle may translate linearly in the direction of the axis, for example, when the nozzle moves relative to the discharge head over the predetermined range of distance, and in some embodiments, the stopper may be linked to the nozzle, for instance, through a rod that extends along the axis within the orifice.

Yet other specific embodiments of the invention, include various improved tools for use by an operator for dispensing drywall joint compound into joints between sheets of drywall that include, for example, a pressure plate, two side plates, a back plate, and a radius plate, which, when the tool is assembled, form a chamber for holding drywall joint compound. In some such embodiments, when the tool is assembled, the pressure plate pivots about a pivot point that may be stationary relative to the side plates, the back plate, and the radius plate. Such embodiments also include at least one spring which applies a force on the pressure plate. In some such embodiments, the at least one spring may include, for instance, a torsion spring and, when the tool is assembled, the torsion spring may be substantially concentric with the pivot point. Certain such embodiments may include other features described herein such as, for example, at least one end plug attached to the torsion spring. In some embodiments, the end plug may be configured to be rotated by the operator to adjust preload of the torsion spring to adjust the force applied by the spring on the pressure plate, for example.

Still other specific embodiments of the invention include various improved tools for use by an operator for dispensing drywall joint compound into joints between sheets of drywall that include, for example, a pressure plate, two side plates, a back plate, and a radius plate, which, when the tool is assembled, form a chamber for holding drywall joint compound, and in some embodiments, when the tool is assembled, the pressure plate pivots about a pivot point that may be stationary relative to the side plates, the back plate, and the radius plate. Such embodiments may further include at least one spring hinge, for example, which applies a force on the pressure plate. In some such embodiments, the at least one spring hinge may include, for instance, a torsion spring and at least one end plug having a regular polygonal portion, and in some embodiments, the polygonal portion may be configured, for instance, to be rotated to adjust preload of the torsion spring and thereby adjust how hard the spring hinge presses against the pressure plate.

Certain such improved tools may further include, for example, a spring lock-out mechanism which, when the tool is assembled, may include, for instance, a first position wherein at least one spring hinge may be allowed to apply spring force on the pressure plate to bias the pressure plate toward the back plate and thereby apply or increase pressure of the drywall joint compound. In some embodiments, the spring lock-out mechanism also may include, for instance, a second position wherein the at least one spring or spring hinge may be held away from the pressure plate to reduce or eliminate the pressure of the drywall joint compound in the chamber. Further, some embodiments may include, for example, an attachment feature, for instance, for removably attaching one at a time a plurality of attachments. In some embodiments, the attachments may include, for example, at least one flat surface and at least one straight edge for smoothing the drywall joint compound in the joints between the sheets of drywall. Further, in particular embodiments, the improved tool may include, for example, at least one attachment having at least two flat surfaces forming a substantially right angle therebetween and at least two intersecting straight edges, for instance, for smoothing the drywall joint compound in an inside corner formed between two of the sheets of drywall.

Still other embodiments include various methods, such as methods of providing for the dispensing of drywall joint compound into joints between sheets of drywall, for example, by obtaining or providing at least one improved drywall tool. Such a method may include, for example, various acts, which may be performed in any order except where order is indicated or apparent. Specific methods include, for example, at least the acts of obtaining or providing a source of pressurized drywall joint compound, obtaining or providing an attachment feature for removably attaching an attachment, and obtaining or providing a valve for controlling the rate of delivery of the drywall joint compound. In a number of embodiments, the attachment may include, for instance, at least one straight edge for smoothing the drywall joint compound in the joints between the sheets of drywall.

Such methods may also include an act of obtaining or providing an enclosed passageway for conveying the drywall joint compound from the source of pressurized drywall joint compound, through the valve, to an attachment that may be attached to the attachment feature, and an act of obtaining or providing a linkage from the attachment feature to the valve, wherein the attachment feature, linkage, and valve are configured so that, at least when the tool is assembled, a force exerted on the attachment feature in at least one direction moves the linkage and opens the valve to release the drywall joint compound into the joints between the sheets of drywall.

In particular embodiments, the act of obtaining or providing the linkage includes obtaining or providing a linkage that is located within the passageway when the tool is assembled. Further, in some embodiments, the act of obtaining or providing the linkage includes obtaining or providing a linkage that is located within the valve, such that the enclosed passageway, the valve, and the linkage are all substantially concentric about the same axis. Even further, in particular embodiments, the act of obtaining or providing the linkage includes obtaining or providing a rod having a first end and a second end, and the act of obtaining or providing the valve includes obtaining or providing a stopper, which, at least when the tool is assembled, is located at the first end of the rod. Some methods may further include, for example, an act of obtaining or providing a nozzle, and in some embodiments, the attachment feature may be located on the nozzle. Moreover, in some embodiments, when the tool is assembled, the second end of the rod may be connected to the nozzle such that the stopper translates with the nozzle, and when the drywall joint compound is dispensed from the tool, the drywall joint compound flows through the nozzle.

Even further, specific embodiments of the invention include various improved tools for use by an operator for dispensing drywall joint compound into joints between sheets of drywall, that may include, for example, a pressure plate, two side plates, a back plate, and a radius plate, which, when the tool is assembled, form a chamber for holding pressurized drywall joint compound. In some such embodiments, when the tool is assembled, the pressure plate pivots about a pivot point that may be stationary relative to the side plates, the back plate, and the radius plate. Further, such embodiments may further include at least one spring which applies a force on the pressure plate to bias the pressure plate toward the back plate and thereby pressurize the drywall joint compound within the chamber when the tool is assembled and the chamber contains the drywall joint compound. Such embodiments may also include a valve configured to control dispensing of the drywall joint compound from the chamber.

In a number of embodiments, such an improved tool may be configured such that, when the tool is assembled and the chamber contains the pressurized drywall joint compound, the valve is normally closed to prevent the drywall joint compound from passing from the chamber, and in some embodiments, the valve may be configured to open to permit the drywall joint compound to pass from the chamber in response to a force vector that is applied to the valve by the operator by pressing the tool against at least one of the sheets of drywall. Further, in some embodiments, when the tool is assembled, the valve may be mounted on the back plate and the back plate may include, for instance, an orifice forming a conduit for the joint compound from the chamber to the valve.

In some embodiments, the at least one spring may include, for instance, a torsion spring, and in some embodiments, when the tool is assembled, the torsion spring may be substantially concentric with the pivot point. Further, in some embodiments, the at least one spring may include, for instance, a spring hinge. Moreover, in particular embodiments, the at least one spring may include a torsion spring, the tool may further include at least one end plug attached to the torsion spring, and, the end plug may be configured to be rotated by the operator to adjust preload of the torsion spring, for example, to adjust the force applied by the spring on the pressure plate. Other embodiments may be described herein or may be apparent to a person of skill in the art.

### DETAILED DESCRIPTION OF EXAMPLES OF EMBODIMENTS

Various embodiments of the invention provide an improved apparatus for dispensing a viscous fluid in a controlled manner. In some embodiments, the viscous fluid may be drywall joint compound, and the apparatus may be a tool for use by an operator for dispensing drywall joint compound into joints between sheets of drywall, for example. In particular embodiments, such a tool may be suitable for, or may be specifically adapted or configured for, applying drywall joint compound to inside corners, for example, where drywall sheets come together at substantially right angles, for instance.

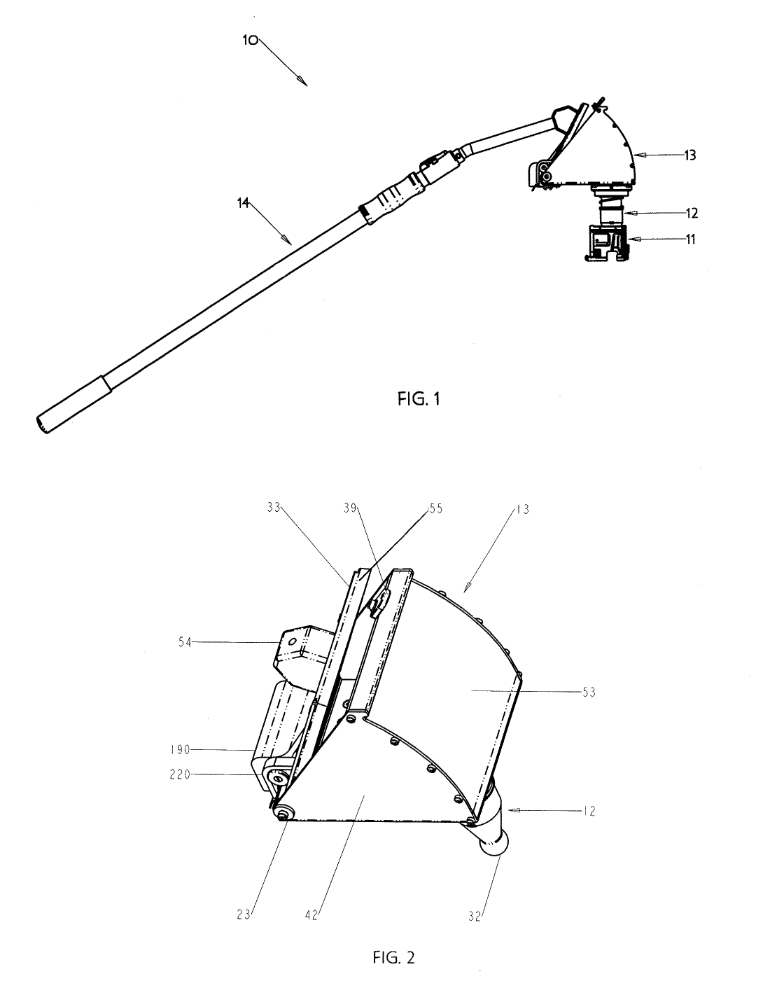

As an example, FIG. 1 illustrates tool 10 for applying drywall joint compound to inside corners where drywall sheets come together at substantially right angles, for instance, which is an example of an apparatus for dispensing viscous fluid in a controlled manner. In this embodiment, tool 10 includes angle head 11, discharge head 12, box or chamber 13, and pole or handle 14. An operator may operate tool 10 by holding on to handle 14 and by pressing angle head 11 against an inside corner of a wall, for example, where sheets of drywall come together. Drywall joint compound may be stored in chamber 13, for instance, and may be discharged through discharge head 12 and angle head 11 when the operator presses angle head 11 against the inside corner.

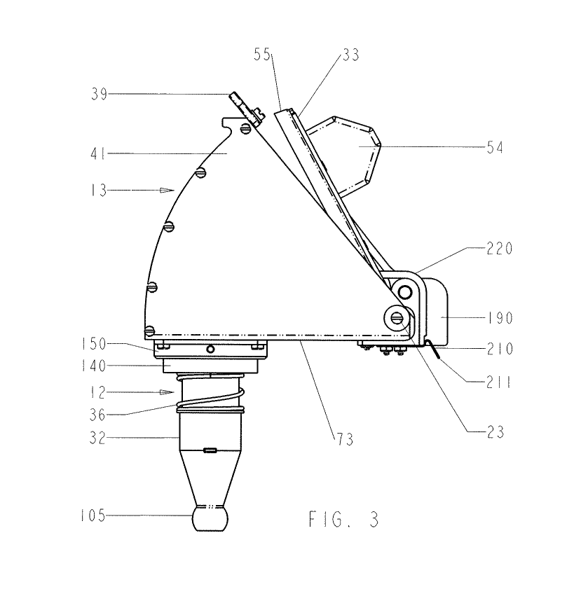

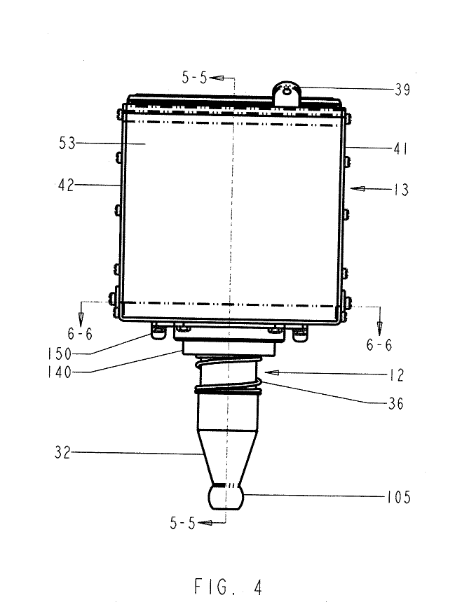

FIGS. 2-9 show the examples of discharge head 12 and chamber 13 in more detail. As illustrated, when the apparatus (e.g., tool 10) is assembled, discharge head 12 is connected to chamber 13, for delivering the viscous fluid (e.g., drywall joint compound) from the chamber through the discharge head. In this embodiment, apparatus or tool 10 includes nozzle 32 which, when the apparatus (e.g., tool 10) is assembled, is connected to discharge head 12 for delivering the viscous fluid (e.g., drywall joint compound) from chamber 13 through discharge head 12 and through nozzle 32. In this embodiment, discharge head 12 and nozzle 32 form a valve that may be used to control the rate of delivery of the viscous fluid or drywall joint compound, for example.

In the embodiment shown, nozzle 32 and discharge head 12 are configured so that nozzle 32 will move relative to discharge head 12 for example, over a predetermined range of distance from a first end of the range of distance to a second end of the range of distance. For example, FIGS. 3-5 and 9 illustrate nozzle 32 at a first end of the range of distance, wherein the valve formed by discharge head 12 is closed. Referring to these views, if nozzle 32 were moved upward as far as possible toward chamber 13 compressing spring 36, then nozzle 32 would be at the second end of the range of distance.

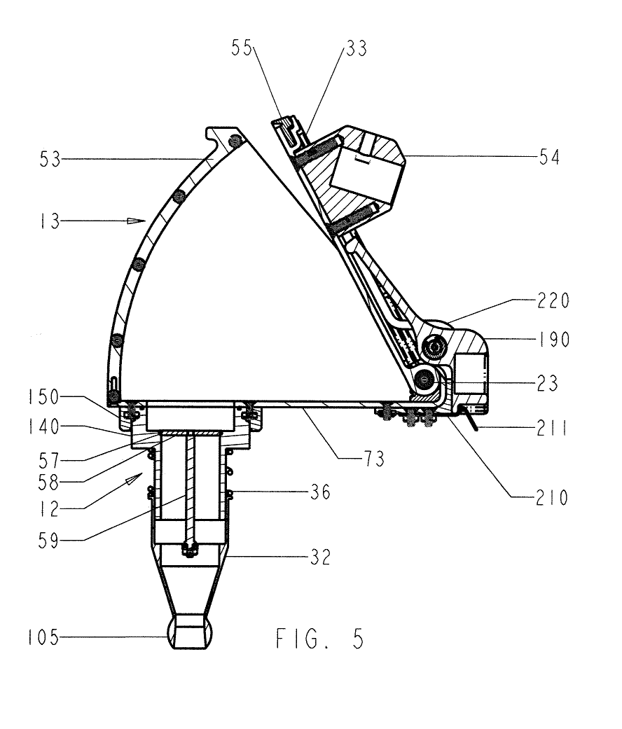

As shown in FIG. 5, in the embodiment illustrated, discharge head 12 includes orifice 57, and when the apparatus or tool (e.g., 10) is assembled and is used for dispensing the viscous fluid (e.g., drywall joint compound), the viscous fluid passes through orifice 57. In FIG. 5, however, stopper 58 which is linked (e.g., through linkage, stem, or rod 59) to nozzle 32, is located in orifice 57, blocking orifice 57 in the position shown. In this embodiment, when nozzle 32 is moved over the predetermined range of distance, stopper 58 moves from blocking orifice 57 at the first end of the range of distance (shown), to not blocking or opening orifice 57 at the second end of the range of distance, for example. Orifice 57 is located in valve bushing 140, which is shown in more detail in FIG. 14. Valve bushing 140 is part of discharge head 12, in this embodiment.

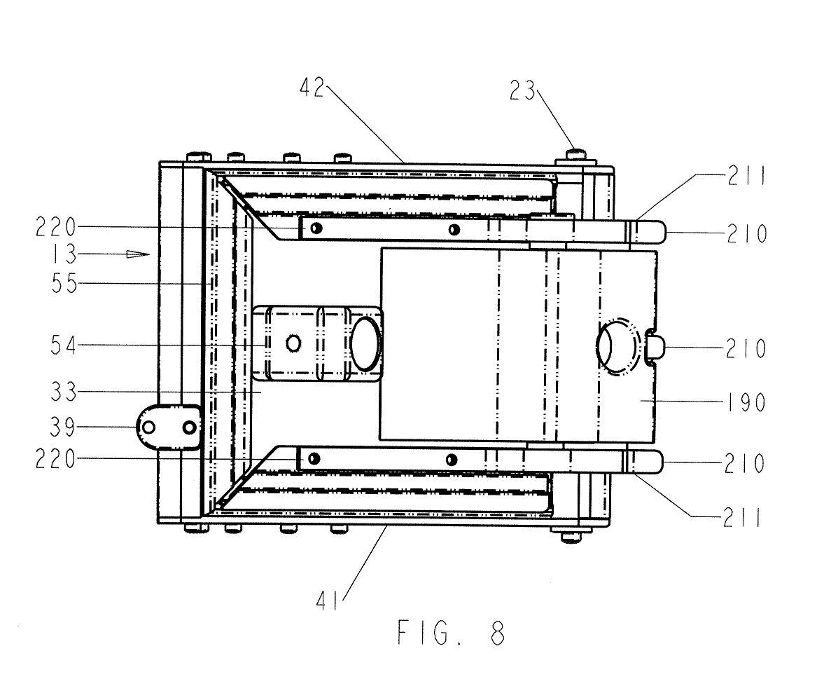

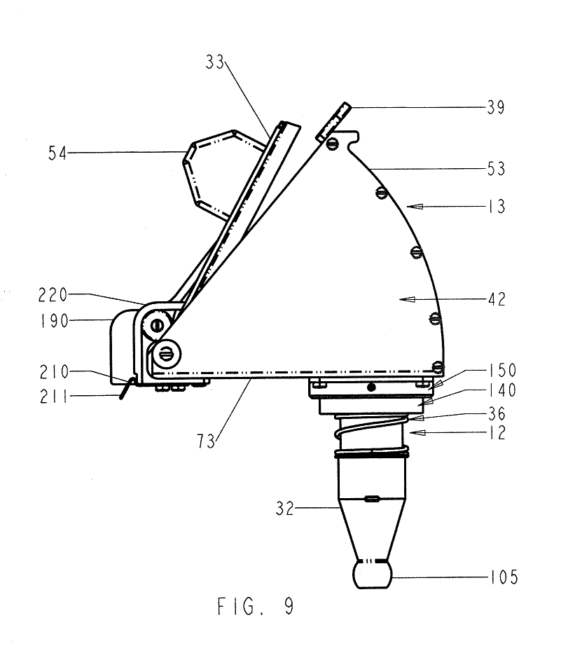

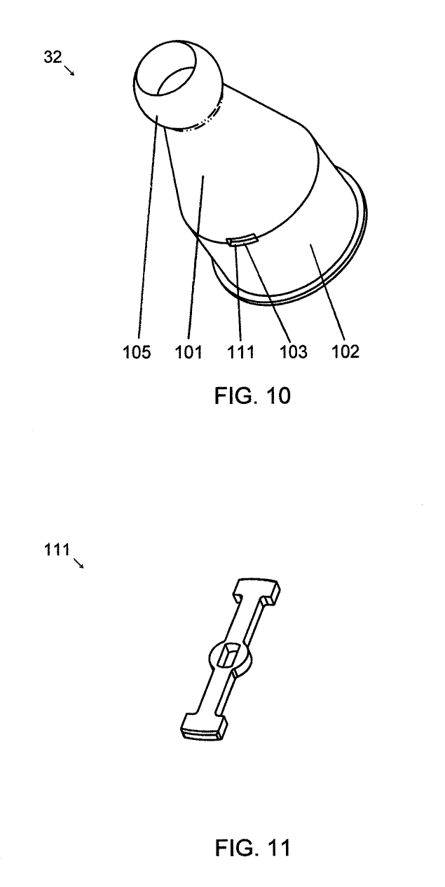

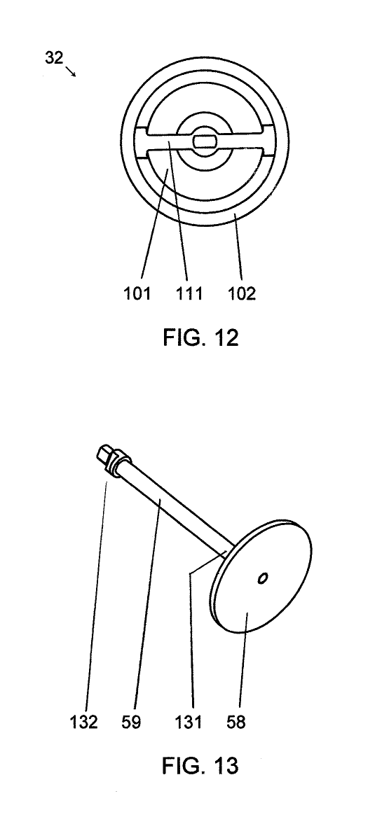

A detail view of nozzle 32 is shown in FIG. 10. Cross member 111, shown in FIG. 11, fits inside nozzle 32 at the base of cone section 101, where cone section 101 attaches to base section 102. In the embodiment illustrated, cone section 101 is welded to base section 102, and cross member 111 is welded to cone section 101 and to base section 102 through window 103 shown in FIG. 10. In this embodiment, two windows 103 are provided on opposite sides of nozzle 32. Cross member 111 is shown inside nozzle 12 in FIG. 12. FIG. 13 shows stopper 58 and stem or rod 59. In the embodiment illustrated, rod 59 attaches to cross member 111 so that stopper 58 translates as nozzle 32 translates against spring 36. In other embodiments, a stopper may be connected to the discharge head, and the orifice may translate as the nozzle moves, as another example.

In the embodiment illustrated, stopper 58 is a round disc, and may be threaded or welded onto stem or rod 59 (or both), for instance. In the embodiment illustrated, nozzle 32, orifice 57, stopper 58, and rod 59 have a substantially common axis, and nozzle 32 translates linearly (e.g., compressing spring 36) in the direction of the axis when nozzle 32 moves relative to discharge head 12 over the predetermined range of distance. This predetermined range of distance may be 0.1, 0.2, 0.25, 0.3, 0.4, or 0.5 inches, as examples. In the embodiment shown, stopper 58 (e.g., round or disk shaped) is linked to nozzle 32 through rod 59 that extends along the axis within orifice 57 (e.g., as shown). In some embodiments, rod 59 and stopper 58 may be formed from the same piece of material (e.g., metal), while in other embodiments, rod 59 and stopper may be separate pieces which may be connected together forming an assembly.

In various embodiments, nozzle 32 comprises a proximal component (e.g., base section 102) and a distal component (e.g., cone section 101), which, when the apparatus is assembled, are attached to each other (e.g., via a weld or threads). Cross member 111 may be a holder or plate, which, when the apparatus is assembled, may be located between the proximal component (e.g., base section 102) and the distal component (e.g., cone section 101), (e.g., welded or squeezed therebetween). In the embodiment shown, rod 59 has a first end 131 and a second end 132, and, at least when the apparatus is assembled, stopper 58 is located at first end 131 and second end 132 is connected to cross member 111. See, for example, FIGS. 5 and 11-13. In some embodiments, as shown, the valve, nozzle 32, or discharge head 12, may further include spring 36, a seal (or seals, for example, such as an o-ring, for instance, between nozzle 32 and valve bushing 140, which may fit, for instance, in a groove in valve busing 130). In some embodiments, a discharge head (e.g., similar to 12) may include a refiller valve, which may be a check valve to allow viscous fluid or drywall joint compound to flow into the chamber.

In the embodiment illustrated, when the tool is in operation, the valve is normally closed (e.g., stopper 58 is in orifice 57, for instance, as biased by spring 36) to prevent the drywall joint compound, for example, from passing from chamber 13 through discharge head 12, and through nozzle 32. In this embodiment, the valve is configured to open to permit the drywall joint compound to pass through discharge head 12 in response to a force vector that is applied to discharge head 12 by the operator by pressing the tool against at least one of the sheets of drywall.

In some embodiments, a chamber, analogous to chamber 13, may include, or may be formed by, a cylinder and a piston, and the apparatus may further include a spring which may apply a force against the piston when the apparatus is assembled and the chamber contains the viscous fluid. The spring may be a helical or coil spring or an air spring, as examples. And in various embodiments, the apparatus further comprises an elongated handle (e.g., similar to 14) which, when the apparatus is assembled, is attached to the chamber. In specific embodiments, the handle may contain at least part of the spring. In particular embodiments, the remaining part of the spring may be located within they cylinder, for example.

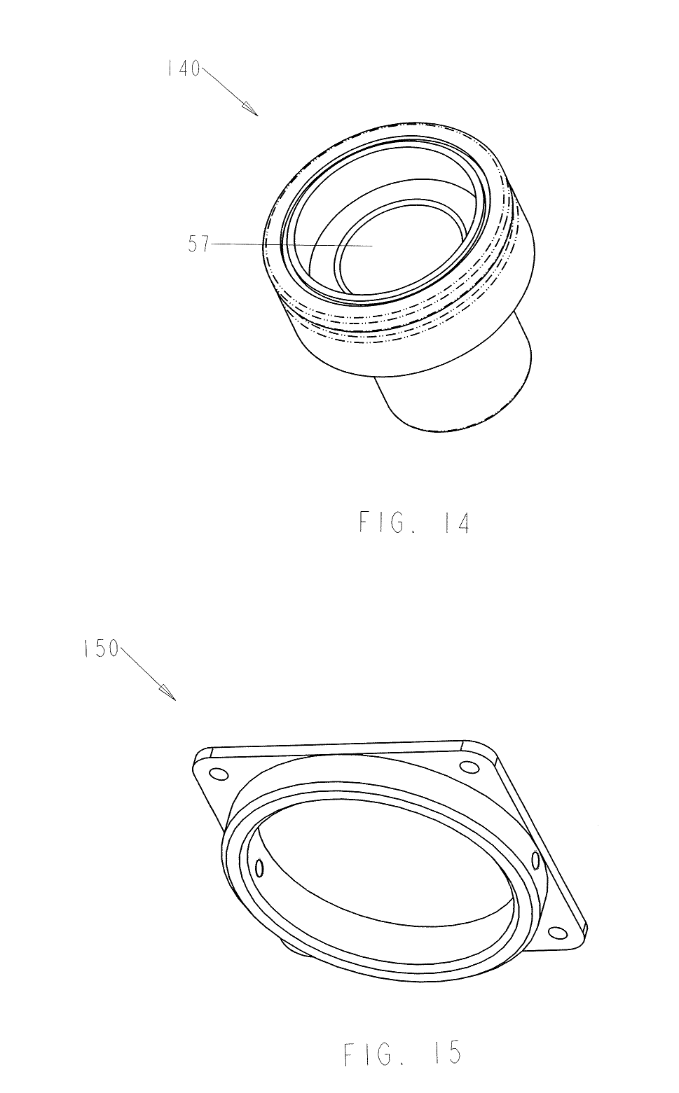

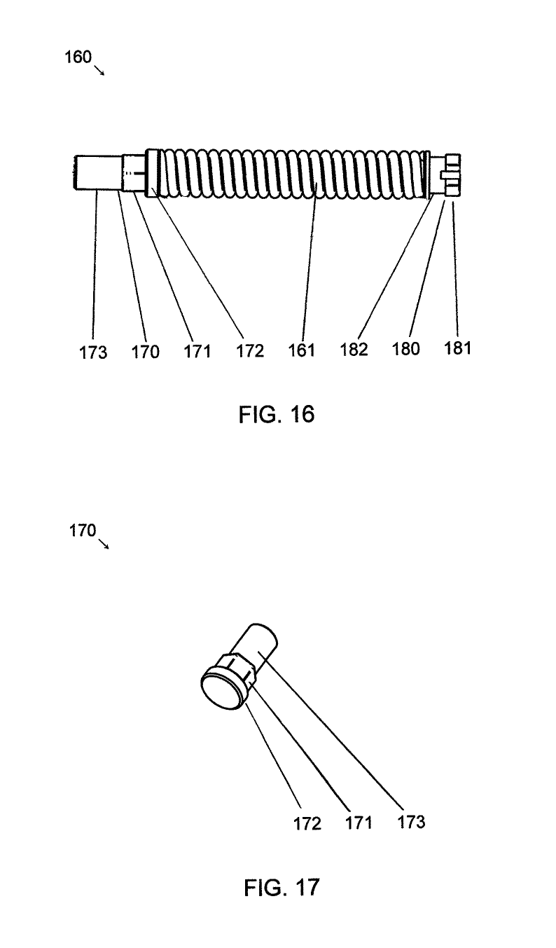

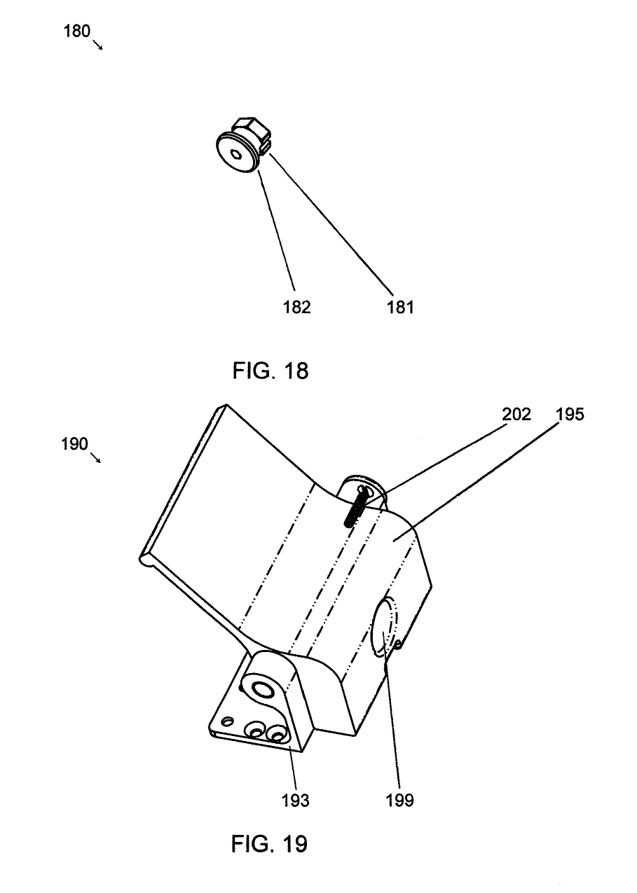

In the embodiment illustrated, on the other hand, chamber 13 mentioned above comprises pressure plate 33, two side plates 41 and 42, back plate 73, and a radius plate 53. Discharge head 12 is attached to back plate 73 via fasteners and bracket 150 shown in FIG. 15. In this embodiment, pressure plate 33 pivots about pivot point 23 that is stationary relative to side plates 41 and 42, back plate 73, and radius plate 53. The apparatus illustrated further includes spring assembly 160 shown in FIG. 16, that includes torsion spring 161, which is welded, in this embodiment, to spring end plugs 170 and 180 shown in FIGS. 17 and 18. In this embodiment, spring assembly 160 applies a force on pressure plate 33, for instance, to bias pressure plate 33 toward back plate 73 and thereby pressurize the viscous fluid (e.g., drywall joint compound) within chamber 13 (e.g., when the apparatus is assembled and chamber 13 contains the viscous fluid).

In other embodiments, on the other hand, the spring (e.g., similar to 161) applies a force on the pressure plate (e.g., similar to 33) to bias the pressure plate away from the back plate (e.g., similar to 73) and thereby avoid having the drywall joint compound issue from the chamber when the tool is assembled and the chamber contains the drywall joint compound. Such embodiments may be similar to traditional flat boxes, for example, except that an improved spring assembly may be used, that may allow for adjustment of the spring force in an improved manner. Such embodiments may omit the valve described herein. In the embodiment illustrated, however, spring 16 applies a force on pressure plate 33 to bias pressure plate 33 toward back plate 73 and thereby pressurize the drywall joint compound within chamber 13 when the tool is assembled and chamber 13 contains the drywall joint compound. In many such embodiments, the tool includes a valve (e.g., discharge head 12, or stopper 58 and orifice 57) configured, for example, to control dispensing of the drywall joint compound from chamber 13.

Certain embodiments may further include an elongated handle (e.g., handle 14) which, when the apparatus is assembled, is attached to pressure plate 33 via handle mount 54. In the embodiment illustrated, handle 14 is extendable, and can be adjusted to different lengths. Handle 14 includes two grips for the worker's hands, and a slight bend. Further, various embodiments include, a seal (or seals) (e.g., 55) which, when the apparatus is assembled, may be mounted on pressure plate 33 and may contact the two side plates 41 and 42 and radius plate 53 to prevent or reduce leakage of the viscous fluid past pressure plate 33. Various components, including the seal, may be similar to what is shown and described in U.S. Pat. No. 7,473,085, U.S. patent application Ser. No. 11/453,455, publication 2007/0292196 (also by Werner Schlecht). In a number of embodiments, when the apparatus is assembled, the dispenser valve assembly or discharge head (e.g., 12) is mounted on back plate 73 and back plate 73 has an orifice therein (e.g., hole or orifice 62 shown in FIG. 6) forming a conduit for the viscous fluid or joint compound from chamber 13 to the valve (e.g., to valve busing 140 and orifice 57).

Further, in particular embodiments, the at least one spring is (or includes) a torsion spring (e.g., spring 161) which, at least when the apparatus is assembled, may be substantially concentric with the pivot point (e.g., 23 of pressure plate 33), for example. Torsion spring 161, in this embodiment, is a helical spring, for example, that is loaded by torsion instead of by pulling or pushing the spring. As used herein, a helical spring is considered to be substantially concentric with a pivot point if the pivot point is located within the outside diameter of the spring. In various embodiments, one end of the torsion spring may be attached (e.g., through one or more other components) to pressure plate (e.g., 33), and the other end of the torsion spring may be attached (e.g., through one or more other components) to a side plate (e.g., 41 or 42) or to the back plate (e.g., 73), so that when pressure plate 33 moves relative to the side plates 41 and 42 and back plate 73 (e.g., about pivot point 23), spring 161 is stressed or distorted (e.g., twisted). Attachment of torsion spring 161 to other components is accomplished with spring end caps or end plugs 170 and 180, in the embodiment illustrated. In various embodiments, the helical spring itself may be attached to the spring end caps or end plugs via a clamp, an interference fit, with threads, with an adhesive, by soldering or brazing, or by welding, as examples.

Further still, in some embodiments, the at least one spring comprises at least one leaf spring. In various embodiments, the at least one leaf spring comprises multiple leaf springs, each leaf spring comprises multiple leaves, or both. Specifically, in particular embodiments, three leaf springs are used, each with two leaves. Other embodiments may have 1, 2, 4, 5, 6, 7, 8, 9, 10, or 12 leaf springs, which may each have 1, 2, 3, 4, 5, 6, 7, 8, or 10 leaves, as examples. For instance, certain embodiments include one primary leaf spring and two parallel mirror-image secondary (multiple) leaves. In some such embodiments, when the apparatus (e.g., tool) is assembled and the chamber is substantially filled with viscous fluid (e.g., drywall joint compound), the at least one leaf spring presses against the pressure plate. In various embodiments, at least one or multiple of the springs or leaves (or both) is removable to alter spring force on the pressure plate and thereby to alter pressure of the pressurized viscous fluid within the chamber.

In particular embodiments, for example, (e.g., when the apparatus is assembled) the at least one leaf spring is attached to the apparatus using at least one threaded fastener (e.g., bolt, nut, or screw) which can be removed (e.g., using a wrench or screw driver, as appropriate) and reinstalled without the spring or leaf in place. In this manner, in some embodiments, some or all of the at least one leaf spring is removable to alter spring force on the pressure plate and thereby alter pressure of the pressurized viscous fluid. This is an example of a means for adjusting spring force for adjusting pressure of the pressurized viscous fluid, and is an example of a means for adjusting pressure of the pressurized viscous fluid. Further, as used herein, “removable” means that a person having the skill of a typical operator can remove and reinstall (e.g., the spring or leaf) with no more than ordinary tools and without damaging the spring or the apparatus (e.g., the tool for dispensing drywall joint compound).

In certain embodiments, each leaf has four holes (e.g., for four fasteners such as bolts or screws) in two rows. Other embodiments may have 1, 2, 3, 5, 6, or 8 holes, or may have slots, as other examples. Holes or slots may be arranged in 1, 2, 3, 4, or more rows, for instance. In particular embodiments, for example, the primary leaf has six holes in a (one) row (e.g., for six fasteners such as bolts or screws), and each secondary leaf has three holes (e.g., for three fasteners such as bolts or screws). Other embodiments may clamp in place rather than having holes. Further, leaf springs and leaves of leaf springs may have bends, for example.

In the embodiment illustrated, nozzle 32 include attachment feature 105, for instance, for removably attaching (e.g., one at a time) a plurality of attachments. In the embodiment shown, attachment feature 105 includes a partially-spherical or ball end (e.g., on the end of nozzle 32 of discharge head 12) which may receive one of the attachments (e.g., 11, for instance, via a snap fit) and may allow the attachment (e.g., 11) to pivot on the ball. Attachment 11 is shown in more detail, for example, in FIG. 23. Various attachments may include, for example, at least one flat surface and at least one straight edge, for instance, for smoothing the drywall joint compound in the joints between the sheets of drywall. In a number of embodiments, the force vector is applied to discharge head 12 by the operator by pressing at least one flat surface or straight edge (or both) against at least one of the sheets of drywall, for instance.

In the embodiment illustrated, angle head or attachment 11 has two flat surfaces 231 and 232 forming a right angle (or a substantially right angle) therebetween, and two intersecting straight edges 233 and 234, for example, for smoothing the drywall joint compound in an inside corner formed between two of the sheets of drywall. As used herein, a “right angle” is between 87 and 93 degrees, and a “substantially right angle” is between 80 and 100 degrees. In some embodiments, multiple angle heads of different sizes may be provided (e.g., with apparatus or tool 10). For example, in some embodiments, three angle heads may be provided having straight edges (e.g., 233 and 234) having lengths of 2, 3, and 4 inches. In other embodiments, angle heads may be provided having straight edges (e.g., 233 and 234) having lengths of 1, 1.5, 2.5, 2.75, 3.25, 3.5, 3.75, 4.5, 5, 6, 7, 8, 9, or 10 inches, as other examples. In the embodiment shown, straight edges (e.g., 233 and 234) have equal lengths, but in other embodiments, the two straight edges may be of differing lengths, for example, a combination of the lengths listed above.

In some embodiments, attachments may be provided having just one flat surface, one straight edge, or both (e.g., one flat surface and one straight edge), for example, for applying drywall joint compound to joints between sheets or pieces of drywall that are between corners of the wall (e.g., straight sections of wall). In certain embodiments, attachments may be provided that have curved surfaces, for instance, for rounded inside corners, as other examples. In particular embodiments, different attachments may provide different radiuses of curvature, for instance. Further, in some embodiments, angle heads may be provided for different angles besides right angles, such as 135 degree angles, or angles of 45, 50, 55, 60, 65, 70, 75, 80, 85, 95, 100, 105, 110, 115, 120, 125, 130, 140, 145, 150, 155, 160, 165, 170, or 175 degrees, as examples. Further, in some embodiments, angle heads or attachments may be provided for outside corners, which may form square or may be rounded corners, for example, having right angles. In particular embodiments angle heads or attachments may be provided for outside corners, which have angles of 45, 50, 55, 60, 65, 70, 75, 80, 85, 95, 100, 105, 110, 115, 120, 125, 130, 135, 140, 145, 150, 155, 160, 165, 170, or 175 degrees, as examples. In certain embodiments, angle heads for rounded outside corners (e.g., for right angles) may be provided having different radiuses of curvature, for instance.

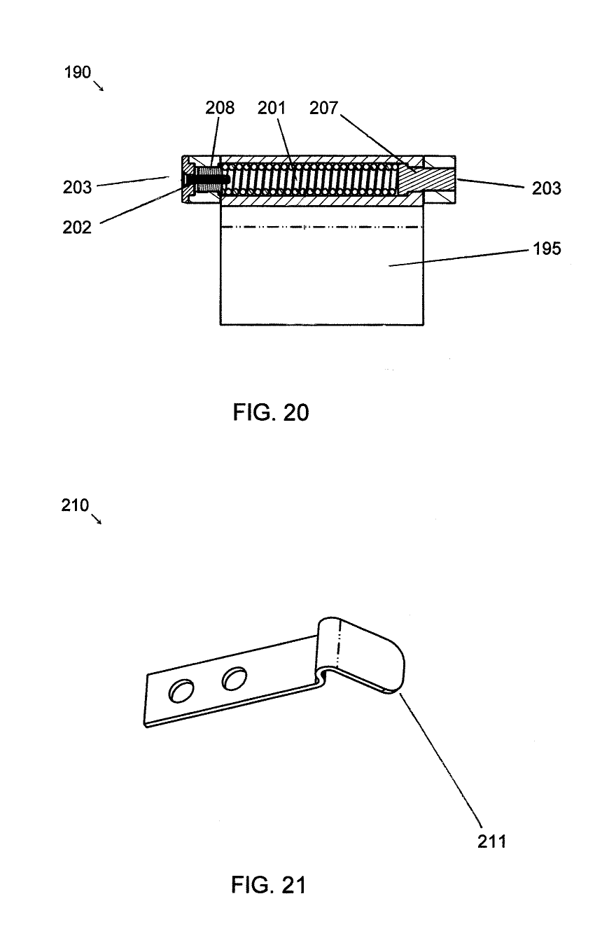

FIG. 19 illustrates spring hinge 190, that includes another torsion spring, spring 201, shown in FIG. 20. In the embodiment illustrated, spring hinge 190 and spring 201 provide supplemental pressure to pressure plate 33, to further pressurize the drywall joint compound within chamber 13. Other embodiments may omit spring 161, or spring hinge 190. In the embodiment shown, when the tool (e.g., 10) is assembled and chamber 13 is substantially filled with drywall joint compound, spring hinge 190 presses against pressure plate 33. As illustrated, spring hinge 190 includes torsion spring 201 (e.g., in addition to torsion spring 161 located in pressure plate 33), and when the tool is assembled, torsion spring 201 is substantially concentric with pivot point 203 of spring hinge 190. In various embodiments, torsion spring 201 of spring hinge 190 may be similar, in many respects, to torsion spring 161 located in pressure plate 33, described herein.

In the embodiment shown, spring hinge 190 includes end plugs 207 and 208 at each end of helical spring 201. End plugs 207 and 208 may be attached to spring 201, for example, by welding, or other attachment methods, such as those described herein. End plugs 207 and 208 may be similar or identical to end plugs 170 and 180 shown in FIGS. 17 and 18.

In various embodiments, one or both end plugs (e.g., 170, 180, 207, or 208) have a regular polygonal portion (e.g., 171 and 181), which may be hexagonal, for example, or octagonal, square, pentagonal, triangular, or the like. In other embodiments, one or both end plugs may have a splined portion or other non-circular shape, as other examples. In some embodiments, the non-circular (e.g., polygonal) portion (e.g., 171 or 181) may engage a similar or mating shape, for instance, in part of the spring hinge (e.g., 190) assembly, and an operator may be able to rotate the end plug (e.g., with a screw driver, Allen wrench, key, or other hand tool inserted into or pressed against the end plug) to adjust the preload of the torsion spring (e.g., by rotating the end plug and thereby adjust how hard the spring hinge, for example, presses against pressure plate 33. This is another example of a means for adjusting spring force, for example, for adjusting pressure of the pressurized drywall joint compound. It is also another example of a means for adjusting spring force for adjusting pressure of a pressurized viscous fluid (e.g., drywall joint compound), and it is an example of a means for adjusting pressure of the pressurized viscous fluid.

Besides spring 201 and end plugs 207 and 208, the embodiment of a spring hinge illustrated includes a “stationary” part 193 that (in the embodiment illustrated) has multiple holes for fasteners to attach to back plate 73, for example. This embodiment also includes moving part 195 that presses against pressure plate 33 and contains (in the embodiment illustrated) a single larger hole 199 for a pry bar to engage a spring lockout mechanism (e.g., as described herein). As shown in FIG. 20, spring hinge 190 includes screw 202, cover cap 203 to keep dirt and debris out (which is held in place with screw 202), and short end plug 208 that rotatably fixes to stationary part 193 via a (male) hexagonal portion (e.g., 181) on the left side that mates with a corresponding (e.g., slightly larger female) hexagonal portion in stationary part 193, and that has a round portion (e.g., 182) on the right side that moving part 195 rotates around. Other embodiments may use another non-round shape besides hexagonal (e.g., as described herein) such as another polygonal shape.

The short end plug 208, (or 180) is welded to helical spring 201, in this embodiment, and long end plug 207 is welded to the other end of spring 201. Long end plug 207 includes (from left to right) a round larger-diameter portion (e.g., 172), a hexagonal medium-diameter portion (e.g., 171) that mates with a corresponding hexagonal portion in moving part 195, and a round smaller-diameter portion (e.g., 173) that acts as a hinge pin and rotates inside stationary part 193. In this embodiment, an operator can remove screw 202 and end cap 203 and then insert a screw driver into the screw hole (e.g., being careful not to damage the screw threads) and can then push the short end plug 208 (or 180) in far enough (against the spring force) to disengage the hexagonal portion (e.g., 181), and then can rotate the short end plug (e.g., 208 or 180) to adjust the preload of the spring (e.g., 201, or similarly, in a number of embodiments, for spring 161).

In some embodiments, the operator may insert a longer screw into the screw hole and then push on and rotate the longer screw rather than inserting the screw driver into the screw hole. Further, in other embodiments, instead of having a hexagonal portion (e.g., 181), the end plug may attach to the cover cap in a manner that makes the end plug and cover cap rotate together, but allows them to move closer or farther away relative to each other. In such embodiments, the operator may then loosen the screw, rotate the cover cap to provide the desired spring preload, and then tighten the screw while holding the cover cap in place, to clamp a lip of the stationary part between the cover cap and the end plug and thus secure the end plug to the stationary part and set the preload. This embodiment provides for continuous adjustment of the spring preload.

Various aspects of spring hinge 190 assembly described herein may also (or instead) be applied to torsion spring 160 inside pressure plate 33, the parts that mate therewith, or both. In different embodiments, such a spring may be used to bias pressure plate 33 toward back plate 73 (e.g., to pressurize the drywall joint compound in an embodiment where expulsion of the drywall joint compound is controlled by a valve), or in some embodiments, the spring (e.g., 161) may be used to bias pressure plate 33 away from back plate 73, for instance, for use in a flat box (e.g., that does not have a valve (e.g., discharge head 12) to control expulsion of the drywall joint compound.

Further, certain embodiments, including the embodiment illustrated, include a spring lock-out mechanism. In a number of embodiments, when the apparatus is assembled, the spring lock-out mechanism may be placed in a first position in which the at least one spring (or spring hinge, in some embodiments) is allowed to apply spring force on the pressure plate to bias the pressure plate toward the back plate and thereby apply or increase pressure of the pressurized viscous fluid. And in some embodiments, the spring lock-out mechanism may also be placed in a second position in which the at least one spring (or spring hinge) is held away from the pressure plate to reduce or eliminate the pressure of the pressurized viscous fluid. In a number of embodiments, the spring lock-out mechanism may be used, for example, for reducing or eliminating pressure of the pressurized viscous fluid to facilitate filling the apparatus with the viscous fluid. This spring lock-out mechanism is another example of a means for adjusting spring force for adjusting pressure of the pressurized viscous fluid, and is another example of a means for adjusting pressure of the pressurized viscous fluid. This spring lock-out mechanism is also an example of a means for reducing or eliminating (or both) pressure of the pressurized viscous fluid to facilitate filling the apparatus with viscous fluid, as another example.

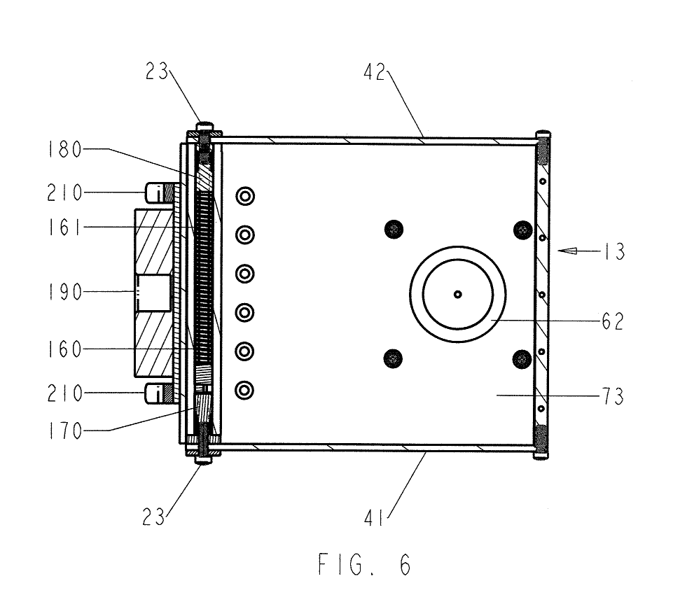

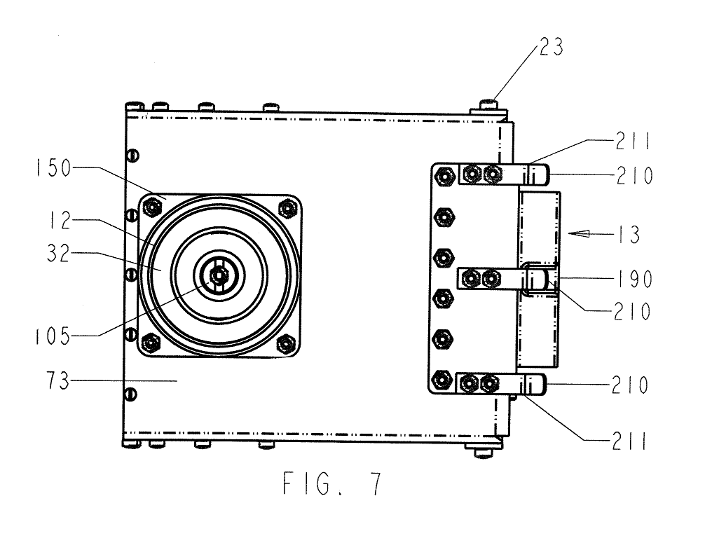

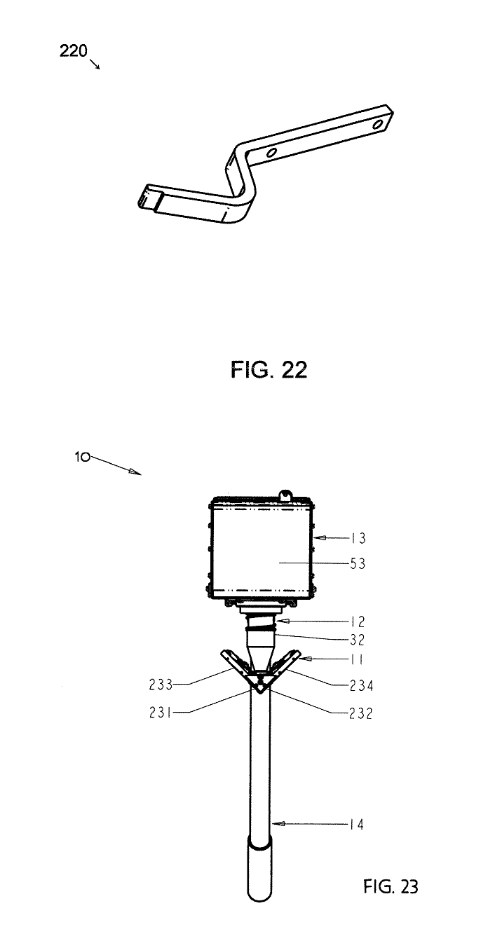

In the embodiment illustrated, the apparatus (e.g., tool 10) or lockout mechanisms includes three spring locks 210, shown, for example, in FIGS. 7 and 21. The outer two of the spring locks 210 engage two lockout bars 220 shown in FIGS. 8 and 22, to hold pressure plate 33 in an open position, for example, as shown in FIGS. 2, 3, 5, and 9. When the apparatus or tool (e.g., 10) is in use, lock lever 39 is rotated from the position shown about a shoulder bolt that attaches lock lever 39 to radius plate 53, so that lock lever 39 blocks pressure plate 33 from opening beyond radius plate 53 and beyond side plates 41 and 42. This prevents accidentally spilling drywall joint compound by opening pressure plate too far, for example, when tool 10 is in use. When the operator need to fill chamber 13, for example, with drywall joint compound, the operator rotates lock lever 39 into the position shown, to allow pressure plate 33 to open beyond radius plate 53 and beyond side plates 41 and 42. The operator then pries pressure plate 33 open to the position sown, for example, with handle 14, at which position the two spring locks 210 engage the two lockout bars 220 to hold pressure plate 33 in the open position.

In this position of pressure plate 33, the operator can then pump drywall joint compound, for example, into chamber 13, for instance, between seal 55 of pressure plate 33 and radius plate 53. The operator may pump the drywall joint compound, for example, with a drywall mud pump, which may have a fitting with a flattened discharge orifice to deliver the drywall joint compound between seal 55 and pressure plate 33. When the operator is finished filling chamber 13, the operator can release the two spring locks 210 by pressing on tabs 211 at the ends of spring locks 210. In this embodiment, spring locks are attached to back plate 73 with fasteners, and lockout bars 220 are attached to pressure plate 33 with fasteners. Such fasteners may be bolts or screws, for example, and may pass through the holes shown.

Further, in the embodiment illustrated, a third spring lock 210, in the center, holds moving part 195 of spring hinge 190 away from pressure plate 33. An operator may insert a pry bar, dowel, piece of pipe, or a handle (e.g., 14) into hole 199 to pry moving part 195 of spring hinge 190 away from pressure plate 33 to engage the third spring lock 210 with moving part 195. This allows the operator to reduce the pressure within chamber 13 by taking spring hinge 190 and spring 201 out of play while still leaving spring 161 in play. Thus the operator can reduce the pressure for situations where less pressure is desired. Another way to engage moving part 195 of spring hinge 190, in some embodiments, is to open pressure plate 33 to the filling position, and then release the outer spring locks 210 but not release the center spring lock 210 that engages moving part 195 of spring hinge 190.

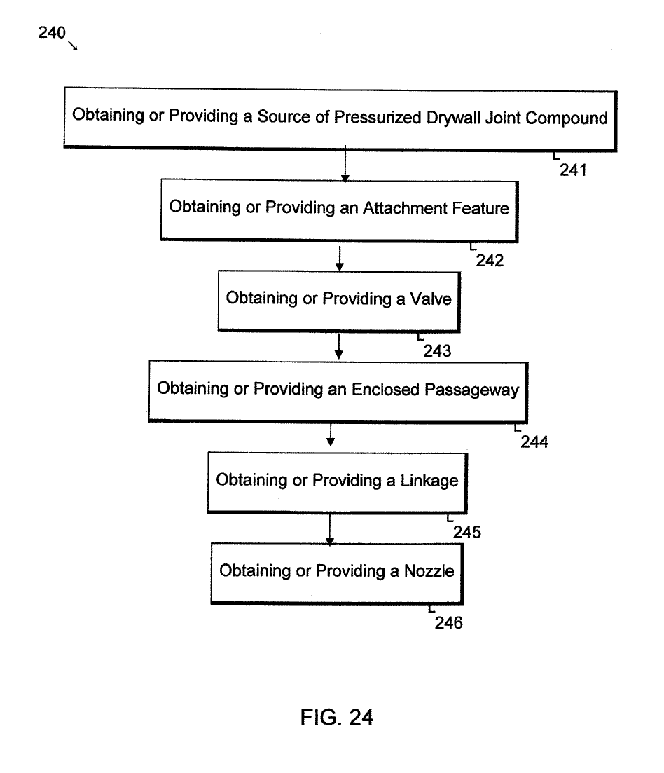

Besides apparatuses, such as tools, a number of embodiments include various processes or methods, for example, of providing for the dispensing of drywall joint compound into joints between sheets of drywall. Such methods may be accomplished, for instance, by obtaining or providing at least one improved drywall tool, for example. Various such methods, for instance, may include in any order various combinations of certain acts. FIG. 24 illustrates an example of such a method, method 240. Method 240 includes act 241 of obtaining or providing a source of pressurized drywall joint compound (e.g., chamber 13), and act 242 of obtaining or providing an attachment feature (e.g., 105), for example, for removably attaching an attachment (e.g., 11). In some embodiments, the attachment (e.g., 11) comprises at least one straight edge (e.g., 233, 234, or both), for instance, for smoothing the drywall joint compound in the joints between the sheets of drywall. In the embodiment illustrated, method 240 also includes act 243 of obtaining or providing a valve (e.g., nozzle 32, discharge head 12, or both), for instance, for controlling the rate of delivery of the drywall joint compound, for example.

Further, other acts in method 240 include act 244 of obtaining or providing an enclosed passageway, for example, for conveying the drywall joint compound from the source of pressurized drywall joint compound (e.g., obtained or provided in act 241, for instance, chamber 13), through the valve (e.g., obtained or provided in act 243), to an attachment (e.g., 11) that is attached to the attachment feature (e.g., obtained or provided in act 242, for instance, attachment feature 105). As an example, orifice 62 shown in FIG. 6, valve bushing 140 shown in FIGS. 5 and 14, and nozzle 32, shown in FIGS. 3-5, 9, and 10, among other things, are an example of such an enclosed passageway (e.g., of act 244). Further, method 240 also includes act 245 of obtaining or providing a linkage, for example, from the attachment feature (e.g., obtained or provided in act 242, for instance, attachment feature 105) to the valve (e.g., obtained or provided in act 243, for instance, the valve formed by discharge head 12 and nozzle 32). In some embodiments, the attachment feature (e.g., 105), linkage (e.g., rod 89, cross member 111, or both), and valve (e.g., formed by discharge head 12 and nozzle 32, including stopper 58 and orifice 57) are configured so that, at least when the tool (e.g., 10) is assembled, a force exerted on the attachment feature (e.g., 105) in at least one direction moves the linkage (e.g., rod 59) and opens the valve to release the drywall joint compound into the joints between the sheets of drywall, for instance. The valve may be opened, for instance, by moving a stopper (e.g., 58) away from a seat or out of an orifice (e.g., 57), as examples.

In some embodiments, act 245 of obtaining or providing the linkage includes obtaining or providing a linkage that is located within the passageway (e.g., obtained or provided in act 244) when the tool (e.g., 10) is assembled. Further, in some embodiments, such a method may include obtaining or providing a linkage (e.g., act 245) that is located within the valve, such that the enclosed passageway, the valve, and the linkage are all substantially concentric about the same axis, for example. As used herein, substantially concentric, when referring to a valve, means concentric to within plus or minus ten percent of the largest radial dimension of the smallest concentric part. Further, in some embodiments, the act of obtaining or providing the linkage (e.g., act 245) includes obtaining or providing a rod (e.g., 59) having a first end (e.g., 131) and a second end (e.g., 132), and the act of obtaining or providing the valve (e.g., act 243) includes obtaining or providing a stopper (e.g., 58), which, at least when the tool (e.g., 10) is assembled, is located at the first end (e.g., 131) of the rod (e.g., 59).

In the embodiment illustrated, method 240 further includes act 246 of obtaining or providing a nozzle (e.g., 32). In some embodiments, the attachment feature (e.g., 105) is located on the nozzle (e.g., 32), and when the tool (e.g., 10) is assembled, the second end (e.g., 132) of the rod (e.g., 59) is connected to the nozzle (e.g., nozzle 32, for example, at cross member 111) such that the stopper (e.g., 58) translates with the nozzle (e.g., 32), and when the drywall joint compound, for instance, is dispensed from the tool (e.g., 10), the drywall joint compound flows through the nozzle (e.g., 32).

In certain embodiments, the act of obtaining or providing a nozzle (e.g., act 246) includes obtaining or providing a proximal component (e.g., base section 102 shown in FIG. 10) and a distal component (e.g., cone section 101) which may include threads or a weld, for example, for attaching the proximal component and the distal component to each other to form the nozzle (e.g., 32). Further, in some embodiments, the method further includes an act of obtaining or providing a cross member (e.g., 111) or a bar or plate, for example, which, when the tool is assembled, may be sandwiched between the proximal component and the distal component of the nozzle, may be welded therebetween, or both, as examples. In some embodiments, when the tool is assembled, the second end of the rod may be connected to the plate (e.g., cross member 111). In certain embodiments, the plate may have holes or passageways therein to allow the viscous fluid or drywall joint compound to flow through. In other embodiments, a bar (e.g., cross member 111) may be used instead of a plate with holes, and the viscous fluid or drywall joint compound may flow around the outside of the bar, for example. Cross member 111 shown in FIG. 11 is an example of such a bar. In some embodiments, the bar, plate, or cross member has a threaded hole, the rod has threads on the end, and the rod is screwed into the hole in the bar. In other embodiments, the rod may be welded to the cross member, or a fitting, fastener, or clip may be used to attach the rod to the cross member (e.g., 111), as other examples.

Other embodiments include various methods of use and various method of manufacture of apparatuses for dispensing viscous fluids or tools for dispensing drywall joint compound, or other components described herein. Methods in accordance with the invention include various combinations of the acts described herein, which may be combined with acts of forming, obtaining, or providing apparatuses or components with various aspects of the structure or function described herein, as examples. Other acts may be apparent from the disclosure herein to a person of ordinary skill in the art

What is claimed is:

1. An improved apparatus for dispensing a viscous fluid in a controlled manner, the apparatus comprising:
a chamber for containing pressurized viscous fluid;
a discharge head which, when the apparatus is assembled, is connected to the chamber for delivering the viscous fluid from the chamber through the discharge head;
a nozzle which, when the apparatus is assembled, is connected to the discharge head for delivering the viscous fluid from the chamber through the discharge head and through the nozzle, wherein the nozzle and the discharge head are configured so that the nozzle will move relative to the discharge head over a predetermined range of distance from a first end of the range of distance to a second end of the range of distance;
an orifice in the discharge head or the nozzle, wherein, when the apparatus is assembled and is used for dispensing the viscous fluid, the viscous fluid passes through the orifice;
a stopper which, when the apparatus is assembled, is linked to the nozzle or to the discharge head, and wherein the nozzle is located in the orifice, wherein, when the nozzle is moved over the predetermined range of distance, the stopper moves from blocking the orifice at the first end of the range of distance, to not blocking the orifice at the second end of the range of distance.

2. The apparatus of claim 1 wherein the nozzle, the orifice, and the stopper have a substantially common axis, wherein the nozzle translates linearly in the direction of the axis when the nozzle moves relative to the discharge head over the predetermined range of distance, and wherein the stopper is linked to the nozzle or to the discharge head through a rod that extends along the axis within the orifice.

3. The apparatus of any of claim 1 wherein the chamber comprises a pressure plate, two side plates, a back plate, and a radius plate, wherein the pressure plate pivots about a pivot point that is stationary relative to the side plates, the back plate, and the radius plate, and the apparatus further includes at least one spring which applies a force on the pressure plate to bias the pressure plate toward the back plate and thereby pressurize the viscous fluid within the chamber when the apparatus is assembled and the chamber contains the viscous fluid.

4. The apparatus of claim 3 wherein, when the apparatus is assembled, the discharge head is mounted on the back plate and the back plate comprises an orifice forming a conduit for the viscous fluid from the chamber to the valve.

5. The apparatus of claim 3 wherein the at least one spring comprises a torsion spring wherein, when the apparatus is assembled, the torsion spring is substantially concentric with the pivot point.

6. The apparatus of claim 3 wherein the at least one spring comprises a spring hinge having a pivot point wherein, when the tool is assembled and the chamber is substantially filled with drywall joint compound, the spring hinge presses against the pressure plate.

7. The apparatus of claim 6 wherein the spring hinge comprises a torsion spring wherein, when the tool is assembled, the torsion spring is substantially concentric with the pivot point of the spring hinge.

8. The apparatus of claim 7 wherein the spring hinge comprises an end plug having a regular polygonal portion, wherein the polygonal portion can be rotated to adjust preload of the torsion spring and thereby adjust how hard the spring hinge presses against the pressure plate.

9. The apparatus of claim 3 further comprising a spring lock-out mechanism for reducing or eliminating pressure of the pressurized viscous fluid to facilitate filling the apparatus with the viscous fluid.

10. A method of providing for the dispensing of drywall joint compound into joints between sheets of drywall by obtaining or providing at least one improved drywall tool, the method comprising in any order at least the acts of:
obtaining or providing a source of pressurized drywall joint compound;
obtaining or providing an attachment feature for removably attaching an attachment, wherein the attachment comprises at least one straight edge for smoothing the drywall joint compound in the joints between the sheets of drywall;
obtaining or providing a valve for controlling the rate of delivery of the drywall joint compound;
obtaining or providing an enclosed passageway for conveying the drywall joint compound from the source of pressurized drywall joint compound, through the valve, to an attachment that is attached to the attachment feature; and
obtaining or providing a linkage from the attachment feature to the valve, wherein the attachment feature, linkage, and valve are configured so that, at least when the tool is assembled, a force exerted on the attachment feature in at least one direction moves the linkage and opens the valve to release the drywall joint compound into the joints between the sheets of drywall.

11. The method of claim 10 wherein the act of obtaining or providing the linkage includes obtaining or providing a linkage that is located within the passageway when the tool is assembled.

12. The method of claim 11 wherein the act of obtaining or providing the linkage includes obtaining or providing a linkage that is located within the valve such that, the enclosed passageway, the valve, and the linkage are all substantially concentric about the same axis.

13. The method of claim 11 wherein:
the act of obtaining or providing the linkage includes obtaining or providing a rod having a first end and a second end; and
the act of obtaining or providing the valve includes obtaining or providing a stopper, which, at least when the tool is assembled, is located at the first end of the rod.

14. The method of claim 13 further comprising an act of obtaining or providing a nozzle, wherein the attachment feature is located on the nozzle, and wherein, when the tool is assembled, the second end of the rod is connected to the nozzle such that the stopper translates with the nozzle, and when the drywall joint compound is dispensed from the tool, the drywall joint compound flows through the nozzle.

15. An improved tool for use by an operator for dispensing drywall joint compound into joints between sheets of drywall, the tool comprising:
a pressure plate, two side plates, a back plate, and a radius plate, which, when the tool is assembled, form a chamber for holding pressurized drywall joint compound, wherein, when the tool is assembled, the pressure plate pivots about a pivot point that is stationary relative to the side plates, the back plate, and the radius plate;
at least one spring which applies a force on the pressure plate to bias the pressure plate toward the back plate and thereby pressurize the drywall joint compound within the chamber when the tool is assembled and the chamber contains the drywall joint compound; and
a valve configured to control dispensing of the drywall joint compound from the chamber.

16. The improved tool of claim 15 wherein, when the tool is assembled and the chamber contains the pressurized drywall joint compound, the valve is normally closed to prevent the drywall joint compound from passing from the chamber, and wherein the valve is configured to open to permit the drywall joint compound to pass from the chamber in response to a force vector that is applied to the valve by the operator by pressing the tool against at least one of the sheets of drywall.

17. The improved tool of claim 15 wherein, when the tool is assembled, the valve is mounted on the back plate and the back plate comprises an orifice forming a conduit for the joint compound from the chamber to the valve.

18. The improved tool of claim 15 wherein the at least one spring comprises a torsion spring wherein, when the tool is assembled, the torsion spring is substantially concentric with the pivot point.

19. The improved tool of claim 15 wherein the at least one spring comprises a spring hinge.

20. The improved tool of claim 15 wherein the at least one spring comprises a torsion spring and wherein the tool further comprises at least one end plug attached to the torsion spring, wherein the end plug is configured to be rotated by the operator to adjust preload of the torsion spring to adjust the force applied by the spring on the pressure plate.
